(19) United States
(12) Patent Application Publication
(10) Pub. No.: US 2025/0347617 A1
(43) Pub. Date: Nov. 13, 2025

(54) DIAGNOSTIC DEVICE WITH IMPROVED OPTICAL SYSTEM

(71) Applicant: Pebble-i Inc., Gunpo-si (KR)

(72) Inventor: Soo Hong KIM, Gwangju-si (KR)

(73) Assignee: Pebble-i Inc., Gunpo-si, Gyeonggi-do (KR)

(21) Appl. No.: 19/204,654

(22) Filed: May 12, 2025

(30) Foreign Application Priority Data
May 10, 2024 (KR) 10-2024-0062154
May 10, 2024 (KR) 10-2024-0062155
Apr. 30, 2025 (KR) 10-2025-0057784

(51) Int. Cl. G01N 21/25

(52) U.S. Cl. CPC G01N 21/255; G01N 2201/06106; G01N 2201/062; G01N 2201/0634; G01N 2201/0636

(57) ABSTRACT

A diagnostic device with an improved optical system is disclosed. The disclosed in vitro diagnostic device has a housing with an inner bottom surface having an arc shape that rises upward from one side where the light source is arranged to the other side where the cartridge sensing surface is arranged. This device may include light sources with different wavelengths arranged on one side of the lower housing. Additionally, it may include an upper housing that is coupled to the upper surface of the lower housing and has a cartridge insertion space for a cartridge with a plurality of wells. The upper housing includes an observation window that covers at least the plurality of sensing hole areas to allow optical observation of the inside of the wells.

### CROSS-REFERENCE TO RELATED APPLICATION(S)

This application claims priority from Korean Patent Application No. 10-2024-0062154, filed on May 10, 2024, Korean Patent Application No. 10-2024-0062155, filed on May 10, 2024, and Korean Patent Application No. 10-2025-0057784, filed on Apr. 30, 2025, in the Korean Intellectual Property Office, the disclosures of which are incorporated herein by reference in their entirety.

### BACKGROUND

### 1. Field

The present disclosure relates to a medical technology, particularly in the field of in vitro diagnostics.

### 2. Description of Related Art

In the field of medical diagnostics, various analytical techniques such as chemical colorimetric assay or immunoassay are employed to detect specific analytes in biological samples including blood, serum, urine, and cell fluid. These analytical techniques are implemented in point of care testing (POCT) devices utilizing test strips or cartridges in clinical test centers.

Multiple-item measuring devices are configured to measure a plurality of test items, wherein it is critical from a measurement reliability perspective to ensure that light emitted from light sources of all wavelengths spatially distributed in the measurement spaces maintains uniform light intensity. For these devices, measurement reliability depends critically on maintaining uniform light intensity across all wavelengths emitted from spatially distributed light sources in separated measurement spaces. The arrangement of measurement spaces and light sources significantly impacts the overall device size during optical system design. Moreover, extended device usage may result in performance characteristics that deviate from initial design specifications due to circuit element deterioration or mechanical wear. Additionally, achieving uniform measurement sensitivity across wells presents a significant challenge for light sensors detecting multiple wavelengths in each measurement well.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present disclosure aims to enhance measurement reliability through uniform sensing sensibility across all light sources in a multiple item testing device that measures transmittance or absorbance of light with multiple wavelengths in a plurality of measurement wells.

Furthermore, the proposed invention aims to maintain measurement reliability despite the degradation of the optical system due to continued use of the in vitro diagnostic device.

According to an aspect of the disclosure proposed to achieve the above objective, an in vitro diagnostic device has a housing with an inner bottom surface having an arc shape that rises upward from one side where the light source is arranged to the another side where the cartridge sensing surface is arranged.

According to an additional aspect, the device may include light sources with different wavelengths arranged on one side of the lower housing.

According to an additional aspect, the device may include an upper housing that is coupled to the upper surface of the lower housing and has a cartridge insertion space for a cartridge with the plurality of wells. The upper housing includes an observation window that covers at least the plurality of sensing holes to allow optical observation of the inside of the wells.

According to an additional aspect, the device may include a two-dimensional image sensor arranged in the upper housing to photograph at least the plurality of sensing holes through the observation window. This two-dimensional image sensor simultaneously photographs the plurality of sensing holes to precisely measure absorbance or reflectance at various wavelengths, thereby increasing the accuracy and reliability of sample analysis results through image processing algorithms.

According to an additional aspect, the device further may include one or more light holes arranged close to the plurality of well areas within the observation window, through which light from the light sources directly passes. The one or more light holes can be used to correct measurement errors caused by light source variations.

According to an additional aspect, the device further may include a control circuit board with memory and a processor mounted in the upper housing. This control circuit board can control the overall operation of the device and process measurement data.

According to an additional aspect, program instructions stored in the memory may be configured to execute a step of calculating a correction value based on the intensity of light reaching the two-dimensional image sensor through the one or more light holes, and storing the calculated correction value as a correction value for the measurement value. This allows for accurate correction of measurement errors caused by light source variations.

According to an additional aspect, the control circuit board further may include a heater arranged along the insertion space of the cartridge and a temperature sensor arranged adjacent to the cartridge, providing an appropriate temperature environment for biochemical reactions in the cartridge.

According to an additional aspect, the upper housing may further includes a diffuser plate that forms part of its bottom surface to fit closely with the lower housing and evenly disperses light. This diffuser plate can further uniformly disperse light generated from light sources to improve measurement accuracy.

According to an additional aspect, the two-dimensional image sensor may include a top substrate, an image sensor mounted on the bottom of the substrate, a barrel with at least one lens array that guides incident light to the image sensor, and a bracket that connects to the upper housing and fixes the optical system. This configuration enables precise measurement by ensuring that the optical axis alignment and top and bottom surfaces are managed with high precision.

According to an additional aspect, a method for factory calibration and in-use calibration is provided. The program instructions of the control circuit board are configured to execute steps including patient information input, applying factory calibration values, executing an in-use calibration sequence, cartridge identification, loading measurement sequence, LED lighting, well brightness measurement, calculation and output of measurement values, etc.

Other features and aspects will be apparent from the following detailed description, the drawings, and the claims.

### BRIEF DESCRIPTION OF THE DRAWINGS

FIG. 1 is an exploded perspective view of a diagnostic device according to an embodiment.

FIG. 2 is an exploded perspective view of each component of the upper housing according to an embodiment of FIG. 1.

FIG. 3 is a cross-sectional view showing the optical structure of the diagnostic device according to an embodiment.

FIG. 4 is a side cross-sectional view of the diagnostic device according to an embodiment.

FIG. 5 is a plan view illustrating a control circuit board of the diagnostic device according to an embodiment.

FIG. 6 is a block diagram illustrating a control system of the diagnostic device according to an embodiment.

FIG. 7 is a flow chart illustrating the operation process of the diagnostic device according to an embodiment.

FIG. 8 is a configuration diagram illustrating a factory calibration system of the diagnostic device according to an embodiment.

FIG. 9 is a flow chart illustrating a factory calibration sequence of the diagnostic device according to an embodiment.

FIG. 10 is a flow chart illustrating an in-use calibration sequence of the diagnostic device according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The aforementioned and additional aspects are embodied through embodiments described with reference to the attached drawings. Components of each embodiment are understood to be possible in various combinations with components of other embodiments unless there is other mention or mutual contradiction. The inventor, based on the principle that the concept of terms can be appropriately defined to explain one's invention in the best way, intends that the terms used in this specification and claims should be interpreted in a meaning and concept consistent with the content of the description or the proposed technical idea.

Hereinafter, the present disclosure will be described in detail through preferred embodiments described with reference to the accompanying drawings for those skilled in the art to easily understand and reproduce the present disclosure. Although specific embodiments are shown in the drawings and detailed descriptions thereof are given, it is not intended to limit various embodiments of the present disclosure to specific forms. In describing the present disclosure, when a detailed description of a related known function or configuration is determined as having the possibility of unnecessarily obscuring the gist of the embodiments of the present disclosure, the detailed description thereof will be omitted.

Blocks expressed as ‘circuits’ or ‘units’ referring to block diagrams in this specification may be composed of hardware such as dedicated semiconductors, gate arrays, FPGAs (Field Programmable Gate Arrays), or parts thereof. One or more blocks may be implemented as a single piece of hardware. For another example, these blocks may be implemented as software by an information processing device where calculation elements execute program instructions stored in memory elements. Multiple blocks may be implemented as part of a program executed on the same calculation element. For another example, these blocks may be implemented in a hybrid form where some parts of individual circuits are hardware and some parts are software. Additionally, in software implementation, the calculation element may include digital signal processors or computational-specific processors, artificial intelligence processing engines, artificial intelligence-specific processors, graphic processors, or combinations of these where possible.

The present disclosure will now be described in detail through preferred embodiments with reference to the attached drawings so that the invention may be easily understood and reproduced by those skilled in the art. While specific embodiments are illustrated in the drawings and relevant descriptions are provided, this is not intended to limit the various embodiments of the proposed invention to a specific form. In explaining the invention, a detailed explanation of related known functions or configurations may be omitted if it is deemed that it might unnecessarily obscure the essence of the embodiment examples of the invention.

When a component is mentioned as being “connected to” or “coupled to” another component, it may be directly connected or coupled to the other component, but it should be understood that there may be another component in between. On the other hand, when a component is mentioned as being “directly connected to” or “directly coupled to” another component, it should be understood that there is no other component in between.

Hereinafter, preferred embodiments of the present disclosure will be described in detail with reference to the accompanying drawings.

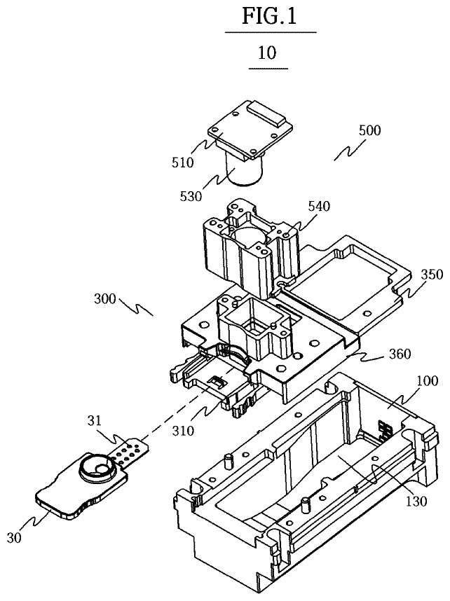

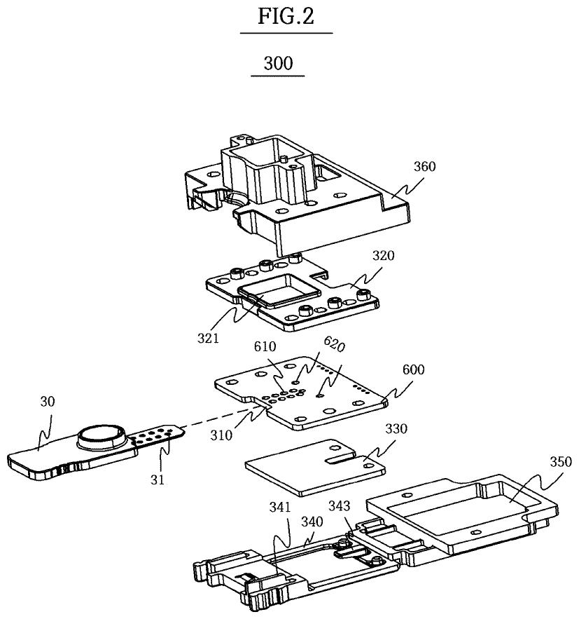

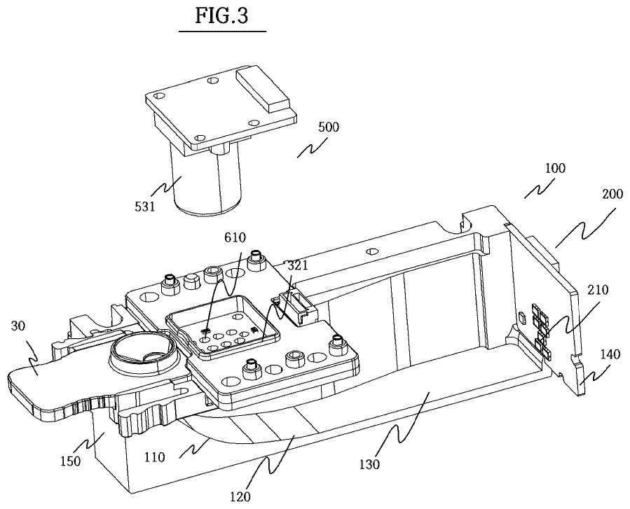

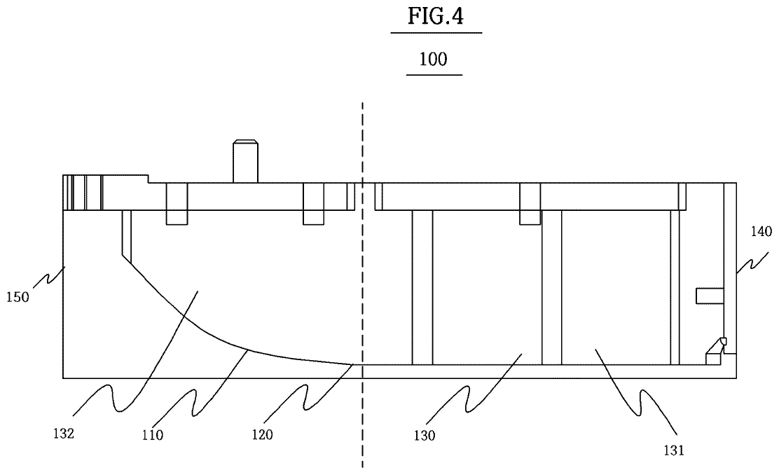

According to an aspect, an in vitro diagnostic device includes a light tunnel 130 where the inner bottom surface of a lower housing 100 has an arc 110 shape rising upward from one side 140 where the light source is arranged to another side 150 where the cartridge sensing surface is arranged. FIG. 1 shows an exploded perspective view of a diagnostic device according to an embodiment where this aspect is applied. FIG. 2 shows an exploded perspective view illustrating a more detailed configuration of the upper housing in the embodiment of FIG. 1. FIG. 3 shows a cross-sectional view of the optical structure of the diagnostic device according to an embodiment of the present invention. FIG. 4 shows a side cross-sectional view of the diagnostic device according to an embodiment of the present invention. A diagnostic device according to an embodiment is described with reference to FIGS. 1 to 4.

As shown, a diagnostic device 10 according to an embodiment where this aspect is applied includes the lower housing 100, a light source module 200, an upper housing 300, and a two-dimensional image sensor 500.

The internal space of the lower housing 100 generally constitutes the light tunnel 130 that guides light from the light source to the cross-section of an observation window 321 where light will be irradiated. In an embodiment, the lower housing 100 includes an inner bottom surface with the arc 110 shape rising upward from the one side 140 to the another side 150. The arc 110 represents the configuration of an optical shape that allows light emitted from the light source module 200 arranged vertically on one side of the lower housing 100 to be reflected and change direction toward a cartridge 30 located on the upper side, having uniform light intensity across the range of the observation window 321 that observes the cartridge 30. As an example, this arc shape may simply be a reflective inclined surface. As another example, the arc 110 shape may be a reflective surface 120 where several planes are arranged along a curve.

Additionally, the lower housing 100 may include a straight light tunnel 131 section with a certain length between the light source module 200 arranged vertically on the one side 140 and the arc 110 shaped light guiding structure. The straight light tunnel 131 section may have a sufficient length for light from multiple light sources spatially separated from each other to become uniform when it reaches the front plane of an arc-shaped light tunnel 132 through reflection and direct progression.

The light source module 200 is arranged on the one side 140 of the lower housing 100. According to an additional aspect, the light source module 200 may include a plurality of LEDs 210 with different wavelengths. The plurality of LEDs 210 are arranged to each generate light of a specific wavelength. As an embodiment of the proposed invention, the plurality of LEDs 210 outputting light with different wavelengths, specifically wavelengths at which biochemical substances show differences in absorbance, such as 450 nm, 620 nm, 870 nm, may be used. By measuring absorbance or transmittance from light sources with multiple wavelengths and combining these results, a specific substance in the sample can be quantitatively measured. Since common wavelengths may be involved in various measurement items corresponding to each well 31, a multiple-item testing device can be implemented by securing light sources in about 7 to 16 wavelength bands to examine various items. In an embodiment, a measurement sequence is determined for each test item, and LEDs with wavelengths included in the determined sequence are selected and sequentially lit, and the absorbance in that wavelength band is measured through a light sensor.

The upper housing 300 is coupled to the top surface of the lower housing 100. Also, the upper housing 300 has a cartridge insertion space 310 for a cartridge 30 with a plurality of wells 31. Additionally, the upper housing 300 includes the observation window 321 that covers at least the plurality of sensing holes 610 and is arranged near the upward position of the arc 110. The cartridge insertion space 310 is a space where the cartridge 30 is loaded into the diagnostic device for measurement, and when loaded and coupled, the plurality of wells 31 of the cartridge 30 each align with the plurality of sensing holes 610 so that light from each well 31 area is shielded between wells 31. The observation window 321 covers the plurality of sensing holes 610.

The two-dimensional image sensor 500 is coupled to the upper housing to photograph at least the plurality of sensing holes 610 through the observation window 321. As shown in FIGS. 1 and 3, the two-dimensional image sensor 500 according to an embodiment can simultaneously photograph the plurality of sensing holes 610 to analyze multiple test items at once. The two-dimensional image sensor 500 according to an embodiment of this diagnostic device 10 may be an image sensor composed of a CCD (Charge-Coupled Device) or a CIS (CMOS Image Sensor) composed of CMOS (Complementary Metal-Oxide-Semiconductor), and may obtain measurement values by reading some of the pixels in each area of the plurality of sensing holes 610.

According to an additional aspect, the arc 110 of the lower housing 100 may have a substantially parabolic shape so that light entering parallel through the light tunnel 130 is uniformly distributed and reflected to the observation window 321 area including the plurality of sensing holes 610. It is known that light incident parallel to the axis of a parabola is reflected to its focus.

As shown in FIGS. 3 and 4, according to an embodiment of the proposed invention, the parabolic arc 110 can efficiently focus light generated from the light source module 200 onto the plurality of sensing holes 610. Due to the characteristics of the parabola, the generated light can reach uniformly distributed focal points across the entire plurality of sensing holes 610.

Furthermore, the arc 110 may include one or more reflection surfaces 120, each arranged at increasing angles to each other on a plane perpendicular to the one side 140 of the lower housing 100. As shown in FIG. 4, according to an embodiment, the one or more reflection surfaces 120 are planar reflective elements, each designed to be arranged at different angles so that light generated from the light source module 200 reaches plurality of sensing holes 610 evenly. The one or more reflection surfaces 120 may be configured so that light is reflected through each reflection surface 120 to illuminate an area slightly larger than plurality of sensing holes 610. This serves to create a uniform light distribution across the entire plurality of sensing holes 610. For example, each reflection surface 120 may have an appropriate angle for reflecting light incident on that reflection surface 120 to one of multiple areas into which the observation window 321 area is divided and allocated among the one or more reflection surfaces 120.

Moreover, according to an embodiment, by designing the one or more reflection surfaces 120, light dispersion can be optimized through each reflection surface 120 having different angles with respect to the one side 130. For example, uniform illumination can be provided without shadows that occur when light is not sufficiently delivered to a specific part of the plurality of sensing holes 610, or hot spots where light is excessively concentrated on a specific area and appears particularly bright. High-reflective coatings may be applied to each reflection surface 120 to minimize light loss, examples of such coatings include aluminum deposition treatment, dielectric multilayer coating, etc. However, the embodiment is not limited to this, and these methods are merely examples of how the one or more reflection surfaces 120 belonging to the lower housing 100 may be formed.

The light tunnel 130 of the lower housing 100 may have a shape that narrows from the one side 140 to the another side 150 when viewed on a plane. For example, the straight light tunnel 131 section, which is close to a straight line in the light tunnel 130, may have a shape that narrows from the one side 140 to the another side 150 when viewed on a plane. As shown in FIGS. 1 and 3, according to an embodiment, the lower housing 100 has a shape that narrows along a curve, allowing light generated from the light source module 200 arranged on the one side 140 to be irradiated and concentrated toward the another side 150. This narrowing shape can help increase the density of the light beam passing through the plane at the other end of the light tunnel, helping to reduce the length of the light tunnel. This allows light to be efficiently guided to the plurality of sensing holes 610 and provides a compact design suitable for point-of-care testing (POCT), providing a miniaturized diagnostic device with improved portability.

The upper housing 300 of the diagnostic device 10 is coupled to the top surface of the lower housing 100. A front cover 340 and a rear cover 350 may be interposed between the lower housing 100 and the upper housing 300. The rear cover 350 covers the top of the straight light tunnel 131 on the one side 140 of the light tunnel 130, and may prevent light generated from the light source module 200 from leaking from inside the light tunnel 130 to the outside. The front cover 340 covers the top of the arc-shaped light tunnel 132 on the another side 150 of the light tunnel 130. In the illustrated embodiment, the front cover 340 serves as a frame that holds and secures the optical diffusion element 330 above. It also forms part of the cartridge insertion space 310 and guides the inserted cartridge 30. That is, as shown, the front of the front cover 340 includes a guide 341 that guides the insertion of the cartridge 30. The rear of the front cover 340 includes a notch 343 that prevents the inserted cartridge from being inserted beyond the position where the plurality of wells 31 of the cartridge align with the plurality of sensing holes 610. To maintain precision when fastening the front cover 340 to the lower housing 100, the front cover 340 is inserted from the front to the rear on the top of the lower housing 100, and as elastic protrusions are fixed in the fixing grooves of the lower housing 100, it is stably assembled.

The upper housing 300 of the diagnostic device 10 may further include an optical diffuser element 330. The optical diffuser element 330 is coupled to fit into the empty space in the middle formed according to the shape of the front cover 340. It forms part of the bottom surface to fit tightly with the lower housing 100 and can evenly disperse light. As shown in FIGS. 2 and 3, the optical diffuser element 330 according to an embodiment can uniformly disperse light generated from the light source module 200 to provide even illumination across the entire plurality of sensing holes 610. Also, the optical diffuser element 330 may be made of a translucent material with a fine surface pattern, which can scatter light to provide uniform illumination. This configuration can greatly improve the reproducibility and accuracy of measurements.

In an embodiment, the upper housing may include a control circuit board 600, which is a circuit board with elements needed for measuring the cartridge 30. This control circuit board 600 has the plurality of sensing holes 610 formed in the observation window 321 area, aligned with each well of the cartridge coupled to it.

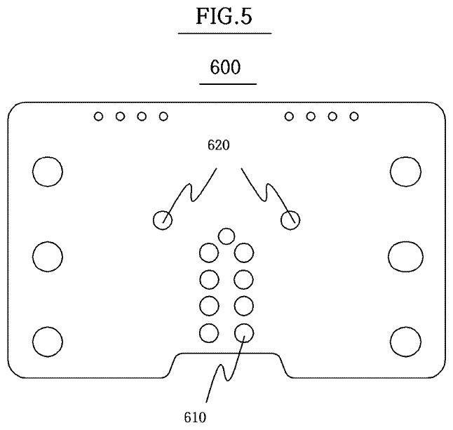

FIG. 5 shows a plan view of the control circuit board of the diagnostic device according to an embodiment of the present invention. According to an aspect, the diagnostic device 10 may further include one or more light holes 620 arranged close to the plurality of sensing holes 610 within the observation window 321, through which light from the light source module 200 directly passes. As shown in FIGS. 3 and 5, the one or more light holes 620 according to an embodiment is a passage that allows light generated from the light source module 200 to reach the two-dimensional image sensor 500 directly without passing through the measurement target, which is the plurality of wells 31, or other elements. According to an embodiment, the one or more light holes 620 is formed in the control circuit board 600 and is placed at a specific position within the observation window 321, but is located outside the area of the plurality of sensing holes 610. The intensity of light measured through the one or more light holes 620 can be used to detect and correct variations in the light source. The two-dimensional image sensor 500 can selectively utilize specific pixels where the one or more light holes 620 is located to acquire data for correction. Correction values, which are data that accurately reflect the current state of the light source module 200 for each measurement session, can be collected, and the collected correction values can be used for correction work to improve the accuracy and reliability of the measurement values.

The cartridge insertion space 310 is formed between the bottom surface of the control circuit board 600, the top surface of the front cover 340, and the top surface of the optical diffuser element 330. The cartridge insertion space 310 may be designed to ensure that the cartridge 30 is seated in the correct position for accurate analysis. According to an embodiment, through the cartridge insertion space 310, the wells 31 of the cartridge 30 can be coupled to match the plurality of sensing holes 610 covered by the observation window 321.

The cartridge 30 is guided for insertion along the guide at the front of the front cover 340, and is inserted until the plurality of wells 31 in the cartridge 30 align with the plurality of sensing holes 610 in the control circuit board 600, then stops when it meets the protruding notch of the front cover 340. Additionally, a heater 430 and a temperature sensor 440 may be mounted on the top surface of the control circuit board 600. The heater 430 may be arranged along the cartridge insertion space 310 of the cartridge 30. In an embodiment, the heater 430 may be a resistor element that heats to a temperature approximately proportional to the current. The heater 430 may be arranged adjacent to the wells of the cartridge 30 to maintain the appropriate temperature required for reactions across the wells 31 of the cartridge 30. The temperature sensor 440 may be, for example, a thermistor or other semiconductor temperature sensor, and it is preferable that it be placed as close as possible to the well of the cartridge 30.

Additionally, a shield plate 320 may include an observation window 321. As shown in FIGS. 2 and 3, the shield plate 320 according to an embodiment is interposed between a sensor coupling cover 360 and the control circuit board 600 to tightly fit the inside of the upper housing 300, protecting the internal optical path while blocking external light. By using multiple fixing pins at both ends so that the top and bottom surfaces of the shield plate 320 are managed with high precision, it can achieve optical axis alignment between the upward-positioned sensor coupling cover 360 and the control circuit board 600. According to an embodiment, the observation window 321 is manufactured to include all the plurality of sensing holes 610, so that light that does not pass through the cartridge 30 can only pass through the observation window 321, increasing the accuracy of measurements.

The sensor coupling cover 360 is located at the top of the upper housing 300 where the two-dimensional image sensor 500 is aligned and fixed. The sensor coupling cover 360 includes a protruding structure to ensure distance from the plane with the plurality of wells area so that the two-dimensional image sensor 500 can photograph the entire observation window area. As shown in FIG. 2, according to an embodiment, the cartridge 30 may be a cartridge as disclosed in Patent Application No. 2025-0046758 filed with the Korean Intellectual Property Office on Apr. 10, 2025, by the present applicant. Such a cartridge includes the plurality of wells 31 containing biochemical samples, allowing multiple test items to be conducted simultaneously. According to an embodiment, the observation window 321 can serve as a window that allows optical observation of the sample reactions inside the wells 31 of the cartridge 30 through the plurality of sensing holes 610.

As an embodiment of the proposed invention, the two-dimensional image sensor 500 may be implemented as a CMOS image sensor (CIS) and may read data using a memory 410 access method. The two-dimensional image sensor 500 can simultaneously photograph the one or more light holes 620 and the plurality of sensing holes 610. By measuring both the one or more light holes 620 and the plurality of sensing holes 610 with the same sensor, variations in light intensity from the light source 200 can be detected in real-time and correction values can be obtained directly. By normalizing the measurement values in the plurality of sensing holes 610 based on the pixel values in the one or more light holes 620 in the captured image, measurement errors due to changes in light source intensity can be effectively compensated.

The two-dimensional image sensor 500 of the diagnostic device 10 may include a top substrate 510, an image sensor 520, a barrel 530 with at least one lens array 531, and a bracket 540. The image sensor 520 is mounted on the bottom surface of the substrate. The at least one lens array 531 guides the incident light to guide the observation window 321 area to the effective light sensing area of the image sensor 520. The barrel 530 optically stably fixes the lens array 531. The bracket 540 connects to the upper housing 300 and fixes the optical system.

According to an embodiment of the diagnostic device, the two-dimensional image sensor 500 can photograph and analyze the plurality of sensing holes 610 as an image. According to an embodiment, the top substrate 510 supports the image sensor 520 and related circuits, and the barrel 530 with the lens array 531 can accurately guide light reflected from the plurality of sensing holes 610 to the image sensor 520.

According to an embodiment, the image sensor 520 may be included in the two-dimensional image sensor 500 and may be composed of a high-resolution CMOS sensor. In this case, it can provide a resolution of about 2 million pixels, detecting even subtle color changes. According to another embodiment, the lens array 531 may be an optically optimized aspherical lens, providing a clear image with minimized distortion. According to an embodiment, the barrel 530 is designed to maintain a precise focal distance, and the bracket 540 serves to firmly fix the entire two-dimensional image sensor 500 to the upper housing 300. This configuration can allow high-quality image acquisition by ensuring that the optical axis alignment and top and bottom surfaces are managed with high precision.

According to this configuration, light with different wavelengths generated from the light source module 200 can pass through the light tunnel 130 inside the lower housing 100, being reflected by the arc 110 and reflection surface 120 to move to the upper housing 300. Light passing through the cartridge insertion space 310 can be irradiated to the observation window 321 area by passing through the sensing holes 610 that match the wells 31 of the cartridge 30 or through the light hole 620. The light can reach the two-dimensional image sensor 500 to be used for analysis and correction. It is important to align the two-dimensional image sensor 500, which is an image sensor assembly, the bracket 540 of the upper housing 300, the sensor coupling cover 360, the front cover 340 that forms a frame supporting the optical diffuser element 330, and the lower housing 100 to ensure the optical path is secured. Accordingly, alignment holes may be provided for each part, and alignment pins (not shown) may penetrate these for assembly.

The diagnostic device 10 may include the control circuit board 600 with program instructions and the memory 410 and at least one processor 420 mounted. Data is stored in the memory 410. The at least one processor 420 serves to execute the program instructions.

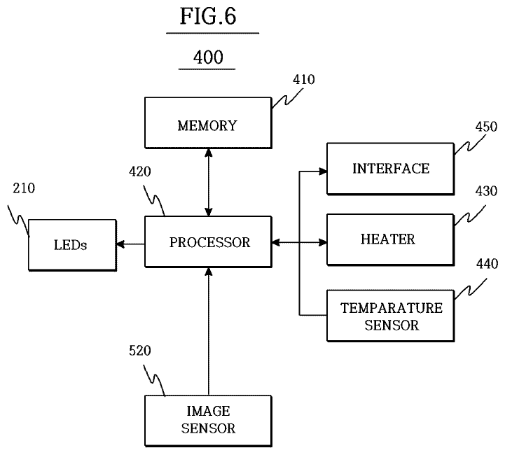

FIG. 6 is a block diagram illustrating the functional configuration of the control board of the diagnostic device according to an embodiment of the present invention. As shown in FIG. 6, the control circuit board 600 can play a central role in controlling the overall operation of the diagnostic device 10.

As shown in FIGS. 6 to 8, among the elements mounted on the control circuit board 600, the memory 410 stores device control, data processing, calibration sequences, analysis algorithms, etc. in the form of program instructions. According to an embodiment, the memory 410 may include non-volatile memory such as EEPROM, flash memory, and RAM (Random Access Memory) including Frame Buffer Memory. Factory calibration parameters may be stored in EEPROM. And data that needs to be maintained even when the power is off, such as operating programs or calibration parameters for in-use calibration, may be stored in flash memory. The processor 420 controls the measurement process by executing these program instructions. According to an embodiment, the processor 420 may be implemented as a low-power, high-performance microcontroller (MCU).

The program instructions of the diagnostic device 10 may be configured to sequentially execute a process of lighting at least some of the plurality of LEDs 210 one by one and measuring the output of the two-dimensional image sensor 500 in the order determined according to the measurement item.

The program instructions of the diagnostic device 10 may be configured to execute a step of calculating a correction value based on the intensity of light reaching the two-dimensional image sensor 500 through the one or more light holes 620, followed by a step of storing the calculated correction value as a correction value for the measurement value. By performing this correction process, the accuracy and reliability of the measurement can be improved.

According to an embodiment, the intensity of light directly measured through the light holes 620 reflects the current state of the light source module 200, and this data can serve to correct the measurement values of light passing through the sensing holes 610. Through the correction process according to an embodiment, separate correction values can be calculated for each wavelength of the plurality of LEDs 210, ensuring accuracy in multi-wavelength measurements. Also, deviations due to temperature changes, such as aging of the light source or deterioration of component characteristics, can also be corrected in this process. The calculated correction values can be stored in the memory 410 to be applied to subsequent measurements.

According to an aspect, the process of calculating and storing correction values to correct the measurement values of the diagnostic device 10 through light passing through the one or more light holes 620 may take place in the factory where the diagnostic device is manufactured, or it may take place during the use of the diagnostic device 10.

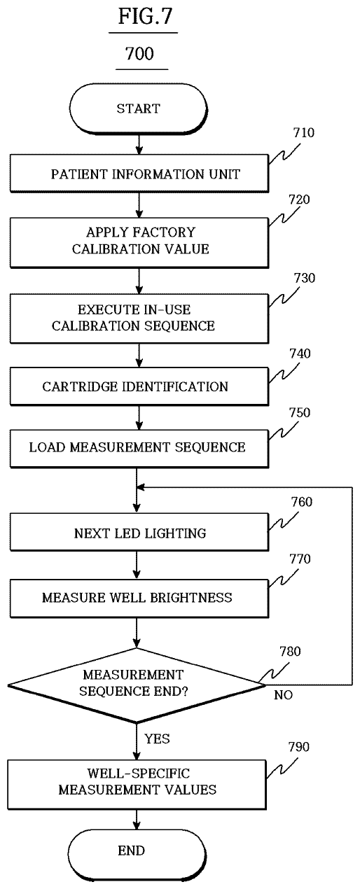

FIG. 7 is a flow chart illustrating the operation process of the diagnostic device according to an embodiment of the present invention. As shown in FIG. 7, according to an embodiment, the diagnostic device 10, when the system starts, may receive information such as gender, age, etc. of individual patients through a user interface such as a touch screen at the patient information input 710 step. Subsequently, at the apply factory calibration value 720 step, factory calibration values stored in the device during the manufacturing process may be applied to improve accuracy. Subsequently, at the execute in-use calibration sequence 730 step, a calibration process suitable for the current usage environment may be conducted. Subsequently, at the cartridge identification 740 step, the cartridge 30 can be identified through information corresponding to the unique barcode in the cartridge 30 inserted for diagnosis.

Subsequently, at the load measurement sequence 750 step, a measurement sequence matching the identified cartridge 30 type can be loaded. Subsequently, at the next LED lighting 760 step, the first LED among the plurality of LEDs 210 can be lit first. Subsequently, at the measure well brightness 770 step, the brightness of the well 31 corresponding to the wavelength of the first LED can be measured. Until the measurement sequence ends, it moves to the next LED lighting 760 step to light the next LED and then measures the brightness of the well 31 corresponding to the wavelength of each LED. The combination of wavelengths measured may vary according to the measurement sequence. After repeating the above process for all LED wavelengths included in the measurement sequence, it reaches the measurement sequence end 780 step. Subsequently, at the calculate and output well-specific measurement values 790 step, measurement values are calculated and output for each well 31 based on the collected data, completing the operation process of the diagnostic device.

The control circuit board 600 may further include an EEPROM (Electrically Erasable Programmable Read-Only Memory) 450 and an interface (I/F) 450. The EEPROM 411 stores factory calibration values. The interface 450 transmits and receives data with external devices. Also, among the program instructions, those that process factory calibration perform factory calibration by proceeding with a factory calibration sequence according to control from an external calibration device through the interface 450, receiving the factory calibration value, and storing it as a correction value in the EEPROM 411 as a correction value.

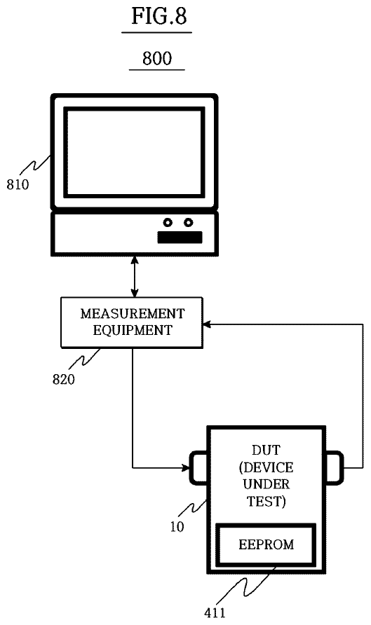

FIG. 8 is a configuration diagram illustrating a factory calibration system of the diagnostic device according to an embodiment of the present invention. As shown in FIG. 8, according to an embodiment, the factory calibration system 800 may include a computer 810 that controls the factory calibration process, measurement equipment 820 that performs bidirectional communication with the computer, and the diagnostic device 10, which is the DUT (Device Under Test) that is the subject of calibration. The DUT may include an EEPROM 411, which is a memory 410 where factory calibration values are stored. The DUT is connected to the measurement equipment and the calibration process proceeds under the control of the computer system, and the resulting values can be stored in the EEPROM 411 of the diagnostic device. Through the factory calibration system 800 according to an embodiment, the deviations between individual devices in the manufacturing process can be corrected to improve the reliability and accuracy of the product.

As shown in FIGS. 6 and 8, according to an embodiment, the factory calibration sequence 900 of the diagnostic device 10 can be one of the important processes for correcting deviations between individual devices in the manufacturing process. The EEPROM 411 is a non-volatile memory that can ensure the reliability of the device regardless of power. The interface 450 is responsible for bidirectional data communication with external calibration devices, allowing stable reception of necessary commands and transmission of measurement data during the factory calibration process, enabling a precise calibration process. According to an embodiment, the interface 450 may be one of the standard protocols such as USB (Universal Serial Bus) or UART (Universal Asynchronous Receiver-Transmitter).

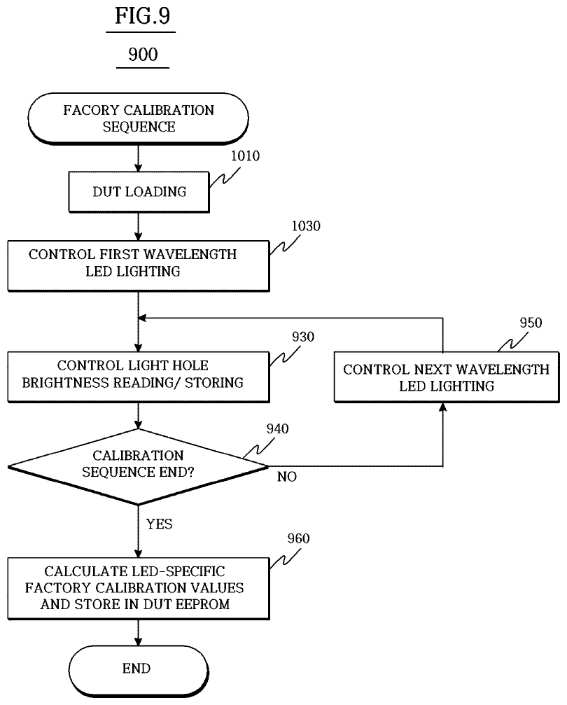

FIG. 9 is a flow chart illustrating a factory calibration sequence of the diagnostic device according to an embodiment of the present invention. As shown in FIG. 9, according to an embodiment, the factory calibration sequence 900 allows each diagnostic device 10 to have its individual characteristics, such as differences in LED light source intensity or sensor sensitivity that may occur during the manufacturing process, corrected so that all products can provide consistent measurement results. First, at the DUT loading 910 step, the DUT is mounted on the measurement system. Subsequently, at the control first wavelength LED lighting 920 step, the LED of the first wavelength can be turned on. Subsequently, at the control light hole brightness reading/storing 930 step, the intensity of light emitted from each LED can be measured through the one or more light holes 620 and that value can be stored. Until reaching the calibration sequence end 940 step, it moves to the control next wavelength LED lighting 950 step to turn on an LED of a different wavelength and repeats the control light hole brightness reading/storing 930 step. Here, this calibration sequence should proceed for all LEDs equipped in the DUT. When calibration for all wavelengths is completed, the calibration sequence end 940 step is finished and it moves to a step of the calculate LED-specific factory calibration values and store in DUT EEPROM 960. At this step, correction values can be calculated by comparing with reference values based on measurements for each LED wavelength using standardized test cartridges. These values can be stored in the EEPROM 411 inside the DUT. The correction values are stored in the EEPROM 411 and maintained even when the power is off, and can be continuously utilized during device use without separate recalibration. Through this factory calibration sequence 900, each diagnostic device has its individual characteristics, such as differences in LED light source intensity or sensor sensitivity that may occur during the manufacturing process, corrected, allowing all products to provide consistent measurement results. These correction values could be, for example, the value of a variable resistor that determines the drive current in the LED driving circuit of the DUT. As another example, these correction values could be offset values added to the measurement values of the DUT's image sensor. These correction values may differ by LED. Additionally, these correction values may also differ by sensing hole to compensate for the non-uniformity of measurement sensitivity within the observation window area.

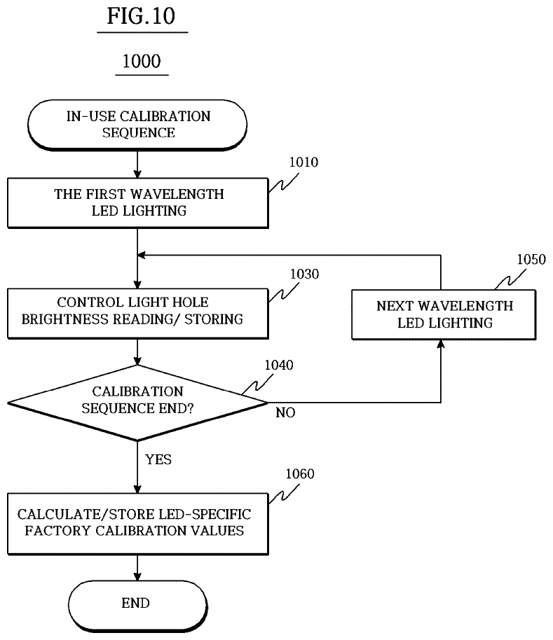

FIG. 10 is a flow chart illustrating an in-use calibration sequence of the diagnostic device according to an embodiment of the present invention. The in-use calibration sequence is to compensate for changes in characteristics due to degradation of optical system components, circuits, or mechanical wear during use, and may be performed each time the diagnostic device is turned on. As shown, when the in-use calibration sequence 1000 starts, firstly the first wavelength LED lighting 1010 step is performed. At this step, the first wavelength LED among the plurality of LEDs in the diagnostic device is lit. Subsequently, the clearing 1020 step is performed. This step may be a process of initializing residual data that may remain from previous measurements. Subsequently, the control light hole brightness reading/storing 1030 step is performed. At this step, the intensity of light from the lit LED that passes through the light holes 620 and reaches the two-dimensional image sensor 500 is measured and stored. Subsequently, a step to determine whether the calibration sequence end 1040 is performed. At this step, it can be confirmed whether calibration for all wavelength LEDs has been completed. If the calibration sequence is not completed (“No” path), it proceeds to the next wavelength LED lighting 1050 step to light an LED of a different wavelength and repeats the previous steps. Similarly, this calibration sequence should proceed for all LEDs equipped in the DUT. If calibration for all wavelengths is completed (“Yes” path), it proceeds to a step of the calculate/store LED-specific factory calibration values 1060. At this step, correction values are calculated based on the brightness values of the one or more light hole 620 measured for each LED wavelength, and these values can be stored in memory, for example, flash memory, which is non-volatile memory. Finally, it reaches the end step and the in-use calibration sequence is completed. Through this in-use calibration sequence 1000, the diagnostic device can effectively correct measurement errors due to light source variations or temperature changes that may occur in the actual usage environment, improving the accuracy and reliability of measurements.

According to an embodiment of the diagnostic device 10, the factory calibration process performs the function of correcting the non-uniform characteristics of the component elements themselves of the driving circuit, such as the output light intensity for input current from LED 210 and the signal value of output current for input light from the CIS component that may constitute the two-dimensional image sensor 500. It also resolves the non-uniformity caused by tolerance, that is, the permissible error that occurs when installing and assembling various components.

The invention has been described above through embodiments with reference to the attached drawings, but it is not limited to these and should be interpreted to encompass various modifications that can be obviously derived from these by those skilled in the art. The patent claims are intended to cover such modifications.

According to the present disclosure, a tunnel-type lighting structure is provided through a lower housing structure with an arc-shaped inner bottom surface, allowing light from multiple light sources to evenly reach a plurality of sensing holes, thereby improving the uniformity and accuracy of measurements.

Furthermore, by using the plurality of LEDs with different wavelengths as light sources, wavelength-specific measurements suitable for various biochemical analyses are possible, increasing the versatility of diagnostics.

In addition, the arc shape of the lower housing having a parabolic form allows focus to be distributed to the plurality of sensing holes, optimizing lighting efficiency and improving measurement accuracy.

In addition, the arc of the lower housing including the one or more reflection surfaces arranged at increasing angles allows light reflected from each reflection surface to evenly illuminate the plurality of sensing holes, improving measurement uniformity.

In addition, the lower housing having a shape that narrows from the one side to the another side when viewed in plan view allows optimization of the optical path and miniaturization of the device.

In addition, by measuring the plurality of wells and calibration light with a single two-dimensional image sensor manufactured to have uniform sensing sensitivity in the sensing area, measurement uniformity and reliability can be improved.

Furthermore, by including the one or more light holes in the observation window, light from the light sources passes directly to reach the two-dimensional image sensor, allowing for accurate correction of light source variations.

Furthermore, through the function of the control circuit board placed in the upper housing to calculate and store correction values based on the intensity of light measured through the one or more light holes, measurement errors due to light source variations are effectively corrected, improving the accuracy and reliability of measurements.

In addition, by including the heater and the temperature sensor in the control circuit board, the temperature of the sample in the cartridge can be precisely controlled, enabling accurate analysis of temperature-sensitive biochemical reactions.

In addition, by including a diffuser plate in the upper housing, light is evenly dispersed, providing more uniform illumination to the sensing holes, improving the reproducibility of measurements.

In addition, by precisely designing and arranging the components of the two-dimensional image sensor, the optical axis alignment and top and bottom surfaces are managed with high precision, enabling high-quality image acquisition and improving measurement accuracy.

Combining these effects, the proposed invention provides a tunnel-type lighting structure that allows multi-wavelength illumination from the light source to evenly reach multiple wells at various positions of the measurement target. The proposed invention effectively corrects measurement errors due to variations in multi-wavelength illumination. The diagnostic device according to the proposed invention is expected to be widely used in the point-of-care testing (POCT) field as an innovative medical diagnostic tool.

Various embodiments disclosed in this specification and drawings only present specific examples to help understanding, and it is not intended to limit the scope of various embodiments of the present disclosure.

Therefore, in addition to the embodiments described herein, all changes or modifications derived based on the technical spirit of various embodiments of the present disclosure should be construed as being included in the scope of various embodiments of the present disclosure.

What is claimed is:

1. A diagnostic device for a cartridge with a plurality of wells comprising:
a lower housing including a light tunnel whose inner bottom surface has an arc shape rising upward from one side to another side;
a light source module arranged on the one side of the lower housing;
an upper housing coupled to an upper surface of the lower housing, including:
a cartridge insertion space for the cartridge;
a plurality of sensing holes each of which corresponds to each of the wells; and
an observation window which covers at least a portion of the sensing holes and is arranged near an upward position of the arc;
and
a two-dimensional image sensor arranged in the upper housing to photograph at least the portion of the sensing holes through the observation window.

2. The diagnostic device according to claim 1, wherein the light source module comprises:
a plurality of LEDs having different wavelengths.

3. The diagnostic device according to claim 1, wherein the arc of the lower housing has a substantially parabolic form having a vertex at a top of the another side and having a symmetry axis parallel to an outer bottom surface, with a focus under the plurality of sensing holes.

4. The diagnostic device according to claim 1, wherein the arc of the lower housing comprises:
one or more reflection surfaces each arranged at increasing angles to each other adjacent surface on a plane perpendicular to the one side of the lower housing.

5. The diagnostic device according to claim 1, wherein the light tunnel of the lower housing has a shape which narrows from the one side to the another side when viewed in plan view.

6. The diagnostic device according to claim 1, wherein the upper housing comprises:
an optical diffuser element which forms a part of a bottom surface of the upper housing to fit tightly with the lower housing and evenly disperse light.

7. The diagnostic device according to claim 1, further comprising:
a light hole arranged close to the plurality of sensing holes within the observation window, through which light from the light source module directly passes.

8. The diagnostic device according to claim 1, further comprising:
a control circuit board on which a memory, which stores program instructions and data, and at least one processor, which executes the program instructions stored in the memory, are mounted.

9. The diagnostic device according to claim 8, wherein the program instructions are configured to sequentially execute a process of lighting at least some of the plurality of LEDs one by one and measuring an output of the two-dimensional image sensor in the order determined according to an individual measurement items.

10. The diagnostic device according to claim 8, wherein the program instructions are configured to perform:
a step of calculating a correction value based on an intensity of light reaching the two-dimensional area image sensor through the light hole; and
a step of storing the calculated correction value as a correction value for a measurement value of the individual measurement item.

11. The diagnostic device according to claim 8, wherein the control circuit board constitute at least a part of an upper surface of the cartridge insertion space, and a heater arranged along the cartridge insertion space and a temperature sensor arranged adjacent to the cartridge are additionally mounted on the control circuit board.

12. The diagnostic device according to claim 8, wherein the control circuit board further comprises:
an EEPROM configured to factory calibration values; and
an interface (I/F) configured to exchange data with external devices; and
wherein the at least one processor is configured to execute the program instructions to:
perform factory calibration according to control from an external calibration device through the interface; and
store a received factory calibration values as a correction values in the EEPROM.

13. The diagnostic device according to claim 1, wherein the two-dimensional image sensor comprises:
a top substrate;
an image sensor mounted on a bottom surface of the top substrate;
a barrel with at least one lens array which guides incident light to the image sensor; and
a bracket which connects to the upper housing and fixes an optical system which directs the incident light to the image sensor.
